(19) United States
(12) Patent Application Publication
(10) Pub. No.: US 2006/0222829 A1
(43) Pub. Date: Oct. 5, 2006

(54) Substrates coated with coating systems that include a treatment layer

(76) Inventors: Roy E. Dean, Lower Burrell, PA (US); Robert T. Pogue, Pittsburgh, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/097,596

(22) Filed: Apr. 1, 2005

(51) Int. Cl. B44C 1/17

(52) U.S. Cl. 428/195.1

(57) ABSTRACT

Disclosed are substrates at least partially coated with a multi-layer composite coating system comprising a treatment layer deposited from a composition comprising a radiation cure initiator, wherein the composition is substantially free of any radiation-curable materials. The present invention is also directed to methods for improving the adhesion of multi-layer coating system to substrates, particularly porous substrates; such as wood.

### FIELD OF THE INVENTION

The present invention relates to substrates at least partially coated with a multi-layer composite coating system comprising a coating layer deposited from a composition comprising a radiation cure initiator and a diluent, wherein the composition is substantially free of radiation-curable material. The present invention is also directed to methods for improving the adhesion of multi-layer coating systems to substrates, particularly porous substrates, such as wood.

### BACKGROUND OF THE INVENTION

There are a number of considerations relevant in the art of protective and decorative coating systems for substrates, such as wood substrates, including cabinets, floors, furniture, and the like. As will be appreciated, such coating systems are often made up of more than one coating layer. Porous substrates, such as wood, for example, are often coated with multi-layer composite coating systems that include a toner layer, a stain layer, a sealer layer, and a topcoat layer. Typically, the toner and/or stain layer(s) are coloring layers, i.e., they provide coloring. The sealer layer is often a protective layer that is sanded to provide a smooth finish, while the topcoat layer is often a protective layer that provides surface properties, such as mar and scratch resistance.

In many cases, the various coating layers in such multi-layer composite coating systems, including the coloring layers such as stains, are deposited from coating compositions that contain radiation curable materials, such as resins that are curable by exposure to ultraviolet (“UV”) radiation. Such resins can provide coatings exhibiting excellent properties, such as adhesion properties, and are often desirable for wood finish applications because of the heat sensitivity of wood, which often makes certain thermosetting coatings unfavorable.

There are some drawbacks, however, to using radiation curable materials in such coating compositions. Capital investment maybe required to provide equipment, such as UV lamps, that are necessary to cure coating compositions that contain radiation curable resins. Moreover, in some cases, such as when it is desired to utilize wiping stains, toxicity issues may prevent the use of certain radiation curable material.

As a result, it is desired to provide coating systems exhibiting acceptable properties, such as adhesion properties, wherein the coating systems include stain and/or toner layers deposited from compositions that are free of radiation curable resins.

### SUMMARY OF THE INVENTION

In certain respects, the present invention is directed to substrates at least partially coated with a multi-layer composite coating system. These coating systems comprise (i) a treatment layer deposited from a composition comprising a radiation cure initiator and a diluent, wherein the composition is substantially free of radiation curable material, (ii) a colorant layer deposited from at least one composition comprising a film-forming resin, a colorant, and a diluent and (iii) at least one of a sealer and topcoat deposited from a radiation curable composition, wherein the sealer and/or topcoat is applied over at least a portion of the colorant layer and the treatment layer.

In other respects, the present invention is directed to methods for improving the adhesion of a multi-layer composite coating system to a porous substrate, wherein the coating system comprises a colorant layer deposited onto the substrate from a composition comprising a film-forming resin, a colorant, and a diluent, and at least one of a sealer and topcoat deposited from a radiation curable composition. These methods comprise the step of depositing a treatment layer from a composition comprising a radiation cure initiator and a diluent to the substrate prior to depositing the sealer and/or topcoat onto the substrate, wherein the composition from which the treatment layer is deposited is substantially free, of radiation curable material.

The present invention is also directed to methods for at least partially coating a porous substrate with the coating systems of the present invention.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to coating systems that comprise a colorant layer. Such references to “a colorant layer” is meant to encompass coating systems comprising one colorant layer as well as coating systems that comprise more than one colorant layer, such as coating systems that comprise two colorant layers. In addition, in this application, the use of “or” means “and/or” unless specifically stated otherwise, even though “and/or” may be explicitly used in certain instances.

As previously indicated, in certain embodiments, the present invention is directed to substrates, such as porous substrates, at least partially coated with a multi-layer composite coating system. As used herein, the term “porous substrate” refers to substrates that contain pores or interstices that allow a liquid composition to penetrate the surface of the substrate. As used herein, the term “multi-layer composite coating system” refers to coating systems that contain at least two coating layers applied successively over a substrate, such as a porous substrate.

Porous substrates within the scope of the present invention include, for example, paper, cardboard, particleboard, fiberboard, wood, wood veneers, and wood products. Suitable woods include, for example, oak, pine and maple. These types of woods are used in the preparation of, for example, kitchen cabinets, bath cabinets, tables, desks, dressers, and other furniture, as well as flooring, such as hardwood and parquet flooring.

As indicated, the substrates of the present invention are at least partially coated with a multi-layer composite coating system comprising a treatment layer deposited from a composition comprising a radiation cure initiator and a diluent. As used herein, the term “radiation cure” refers to polymerization that occurs upon exposure of a material to an energy source, such as an electron beam (EB), UV light, or visible light.

In certain embodiments, the radiation cure initiator comprises a photoinitiator selected from a cationic photoinitiator and/or a free radical photoinitiator. As used herein, the term “cationic photoinitiator” refers to photoinitiators that initiate cationic cure, while the term “free radical photoinitiator” refers to materials that initiate free radical cure. For example, in cases where the coating compositions of the present invention are to be used in a coating system in conjunction with a coating layer deposited from a radiation curable composition that comprises a radiation curable material susceptible to cationic cure, as described in more detail below, it is often desirable to include a cationic photoinitiator in the coating composition of the present invention. Conversely, in cases where the coating compositions of the present invention are to be used in a coating system in conjunction with a coating layer deposited from a radiation curable composition that comprises a radiation curable material susceptible to free radical cure, as described in more detail below, it is often desirable to include a free radical photoinitiator in the coating composition of the present invention.

Examples of cationic photoinitiators suitable for use in the present invention include, for example onium salts aromatic diazonium salts of complex halides, certain metallocenes, and combinations thereof.

Suitable onium salts include for example, those having the formulas, R₂I⁺MX_{z}, R₃S⁺MX_{z}⁻, R₃Se⁺MX_{z}⁻, R₄P⁺MX_{z}⁻ and R₄N⁺MX_{z}⁻, wherein each R is an organic group having from 1 to 30 carbon atoms, for example, aromatic carbocyclic groups having from 6 to 20 carbon atoms. Each R group can be substituted with from 1 to 4 monovalent hydrocarbon groups, for example alkoxy groups having from 1 to 8 carbon atoms, alkyl groups having from 1 to 16 carbon atoms, nitro, chloro, bromo, cyano, carboxyl, mercapto, or aromatic heterocyclic groups exemplified by pyridyl thiophenyl, and pyranyl. MX_{z}⁻ is a non-basic, non-nucleophilic anion, for example, an inorganic anion such—as BF₄⁻, B(C₆F₅)₄⁻, PF₆⁻, AsF₆⁻, SbF₆⁻, SbCl₆⁻, HSO₄⁻, ClO₄⁻, FeCl₄⁻, SnCl₆⁻, or BiCl₅⁻; the anion of an organic sulfonic acid, such as benzene sulfonic acid, dodecylbenzene sulfonic acid, or 3-nitrobenzene sulfonic acid; or the anion of a perfluoroalkylsulfonic acid, for example perfluorobutanesulfonic acid, perfluoroethanesulfonic acid, perfluorooctanesulfonic acid, or a combination thereof.

More specific examples of suitable onium salts are diaryliodonium salts of sulfonic acid; diaryliodonium salts of boronic acids, for example, tolyl cumyliodonium tetrakis(pentafluorophenyl) borate; bis(dodecyl phenyl) iodonium hexafluoroarsenate; bis(dodecylphenyl) iodonium hexafluoroantimonate; dialkylphenyl iodonium hexafluoroantimonate; triarylsulfonium salts of sulfonic acid; triarylsulfonium salts of perfluoroalkylsulfonic acids; and triarylsulfonium salts of aryl sulfonic acids; triarylsulfonium salts of perfluoroalkylsulfonic acids, or a combination thereof.

Suitable aromatic diazonium salts of complex halides, include, for example, 2,4-dichlorobenzenediazonium tetrachloroferrate(III), p-nitrobenzenediazonium tetrachloroferrate(III), p-morpholinobenzenediazonium tetrachloroferrate(III), 2,4-dichlorobenzeneddiazonium hexachlorostannate(IV), p-nitrobenzenediazonium hexachlorostannate(IV), 2,4-dichlorobenzenediazonium tetrafluoroborate, or a combination thereof.

Also suitable are certain metallocenes, for example the ferrociniums having the formula [R^{a} (Fe¹¹ R^{b})_{c}]_{d}^{+c}[x]_{c}^{-d}, wherein, c is 1 or 2; d is 1, 2, 3, 4 or 5; X is a non-nucleophilic anion, for example BF₄—, PF₆⁻, AsF₆⁻, SbF₆⁻, SbF₅(OH)⁻, CF₃SO₃⁻, C₂F₅SO₃⁻, n-C₃F₇SO₃⁻, n-C₄F₉SO₃⁻, n-C₆F₁₃SO₃⁻, n-C₈F₁₇SO₃⁻, C₆F₅SO₃⁻, phosphorus tungstate, or silicon tungstate; R^{a} is a pi-arene, and R^{b} is an anion of a pi-arene, such as a cyclopentadienyl anion. Examples of suitable pi-arenes are toluene xylene, ethylbenzene, cumene, methoxybenzene, methyinaphthalene, pyrene, perylene, stilbene, diphenylene oxide and diphenylene sulfide. An example of a visible light cationic photoinitiator is (η₅-2,4-cyclopentadien-1-yl)(η₆-isopropylbenzene)-iron(II) hexafluorophosphate, available-under the trade name IRGACURE 261 from Ciba. Other commercially available cationic photoinitiators suitable for use in the present invention include CYRACURE UVI-6992 and CYRACURE UVI-6976 from Dow Chemical Company.

To increase the light efficiency, or to sensitize the cationic photoinitiator to specific wavelengths, it is also possible, depending on the type of initiator, to use sensitizers. Examples are polycyclic aromatic hydrocarbons or aromatic keto compounds, for example benzoperylene, 1,8-diphenyl-1,3,5,7-octatetraene, or 1,6-diphenyl-1,3,5-hexatriene.

Examples of free radical photoinitiators suitable for use in the present invention include, for example, alpha-cleavage photoinitiators and hydrogen abstraction photoinitiators. Cleavage-type photoinitiators include acetophenones, α-aminoalkylphenones, benzoin ethers, benzoyl oximes, acylphosphine oxides and bisacylphosphine oxides and mixtures thereof. Abstraction-type phbtoinitiators include benzophenone, Michler's ketone, thioxanthone, anthraquinone, camphorquinone, fluorone, ketocoumarin and mixtures thereof.

Specific nonlimiting examples of photoinitiators suitable for use in the present invention include benzil, benzoin, benzoin methyl ether, benzoin isobutyl ether benzophenol, acetophenone, benzophenone, 4,4′-dichlorobenzophenone, 4,4′-bis(N,N′-dimethylamino)benzophenone, diethoxyacetophenone, fluorones, e.g., the H-Nu series of initiators available from Spectra Group Ltd., 2-hydroxy-2-methyl-1-phenylpropan-1-one, 1-hydroxycyclohexyl phenyl ketone, 2-isopropylthioxantone, α-aminoalkylphenone, e.g., 2-benzyl-2-dimethylamino-1-(4-morpholinophenyl)-1-butanone, acylphosphine oxides, e.g., 2,6-dimethylbenzoyldiphenyl phosphine oxide, 2,4,6-trimethylbenzoyidiphenylphosphine oxide, bis (2,4,6-trimethylbenzoyl) phenyl phosphine oxide, 2,6-dichlorobenzoyl-diphenylphosphine oxide, and 2,6-dimethoxybenzoyidiphenylphosphine oxide, bisacylphosphine oxides, e.g., bis(2,6-dimethyoxybenzoyl)-2,4,4-trimethylepentylphbsphine oxide, bis(2,6-dimethylbenzoyl)-2,4,4-trimethylpentylphosphine oxide, bis (2,4,6-trimethylbenzoyl)-2,4,4-trimethylpenty phosphine oxide, and bis(2 ,6-dichlorobenzoyl)-2,4,4-trimethylpentylphosphine oxide, and mixtures thereof.

In certain embodiments, the treatment layer is deposited from a composition that comprises 0.01 up to 15 percent by weight of photoinitiator or, in some embodiments, 0.01 up to 10 percent by weight, or, in yet other embodiments, 0.01 up to 5 percent by weight of photoinitiator, based on the total weight of the composition.

In certain embodiments, the composition from which the treatment layer is deposited also comprises an organo-silicon or organo-fluorine containing molecule or polymer, such as an organo silane. Non-limiting examples of suitable organo silanes include vinyl and allyl halo, alkoxy, amino organo, acryloxy or methacrylate silanes, their hydrolysis products and polymers of the hydrolysis products and mixtures of any of these materials. Some of these silanes are disclosed in U.S. Pat. Nos. 2,688,006; 2,688,007; 2,723,211; 2,742,378; 2,754,237; 2,776,910; and 2 799,598. In certain embodiments, the treatment layer is deposited from a coating composition that comprises an amino silane, an epoxy silane, or, in some cases, a mixture thereof.

Non-limiting examples of suitable amino silanes are monoamino and diamino silanes, including y-aminopropyltriethoxysilane, N-(trimethoxysilypropyl)ethane diamine acrylamide and other similar mono and diamino silanes. Lubricant modified amino silanes may also be used. In certain embodiments, such monoamino silanes have an amino functionality designated by the general formula:
NH₂R—Si—(OR¹ )₃
wherein R is an alkylene radical having from 2 to 8 carbon atoms and R¹ is a lower alkyl radical or hydrogen (the lower alkyl radical having from 1 to 5 carbon atoms, such as 1 to 2 carbon atoms). Additional examples of suitable amino silanes include aminomethyltriethoxysilane, aminopropyltrimethoxysilane, γ-aminopropyltrimethoxysilane, aminoethylaminopropyltrimethoxysilane, diaminopropyldiethoxysilane, triaminopropylethoxysilane, and the like.

Also suitable are epoxy silanes, such as those designated by the formula: 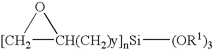
wherein R¹ is as described above and y is an integer having a value ranging from 1 to 6. Representative examples of such epoxy silanes include β-hydroxyethyltriethoxysilane, γ-hydroxypropyltrichlorosilane, bis-(Δ-hydroxybutyl)dimethoxysilane, Δ-hydroxybutyltrimethoxysilane, 2,3-epoxypropyltrimethoxysilane, 3,4-epoxybutyltriethoxysilane, and bis-(2,3-epoxypropyl)dimethoxysilane, glycidoxypropyltrimethoxysilane, 3,4-epoxycyclohexyltriethoxysilane.

Suitable organo-silicon containing polymers include homopolymers, copolymers or block polymers and can be of virtually any length and complexity so long as the molecule does not interfere with desired properties of the coating composition. The polymers can be, without limitation, acrylics, polyesters, polyethers, polysiloxanes, urethanes or combinations thereof. In certain embodiments, the polymer comprises the reaction product of one or more monomers in which at least one monomer has a pendant silyl group. The polymer can be a homopolymer of silyl group-containing acrylic monomers or a co-polymer of two or more acrylic monomers, one of Which includes a pendant silyl group. A suitable acrylic monomer which includes a pendant silyl group is y-methacryloxypropyltrimethoxysilane (SILQUEST® A-174 silane commercially available from OSI Specialties Inc.). Such a monomercan be reacted with a suitable vinyl monomer, such as an acrylic monomer, such as methyl (meth)acrylate, ethyl (meth)acrylate, butyl (meth)acrylate, ethylhexyl (meth)acrylate, stearyl (meth)acrylate, benzyl (meth)acrylate, cyclohexyl (meth)acrylate, lauryl (meth)acrylate, isobornyl (meth)acrylate hydroxypropyl (meth)acrylate, hydroxyethyl (meth)acrylate, hydroxybutyl (meth)acrylate, trifluoroethyl (meth)acrylate, pentafluoropropyl (meth)acrylate, perfluorocyclohexyl (meth)acrylate, (meth)acrylonitrile glycidyl (meth)acrylate, dimethylaminoethyl (meth)acrylate, diethylaminoethyl (meth)acrylate, (meth)acrylamide, alpha-ethyl (meth)acrylamide, N-butoxymethyl (meth)acrylamide, N,N-dimethyl acrylamide, N-methyl acrylamide, acryloyl morpholine and N-methylol (meth)acrylamide or a combination thereof.

Any number of other silanes containing at least one organic group substituted by one or more of an amino group or an epoxy group may also be used in the composition from which the treatment layer is formed, and these silanes are well known to those skilled in the art. In certain embodiments, such compositions comprise up to 2 percent by weight of organo silane or, in some embodiments, 0.1 up to 2 percent by weight of organo silane, based on the total weight of the composition. As previously indicated, the treatment layer is deposited from a composition that comprises a diluent. Suitable diluents include organic solvents, water, and/or water/organic solvent mixtures. Suitable organic solvents include, for example, alcohols, ketones, aromatic hydrocarbons, glycol ethers, esters or mixtures thereof in certain embodiments, the diluent is present in the composition from which the treatment layer is deposited in an amount ranging from 85 to 99.99 weight percent based on total weight of the composition, such as 95 to 99 9 percent.

In the present invention, the treatment layer is deposited from a composition that is substantially free or in some cases, completely free, of radiation curable material. As used herein, the term “radiation curable material” refers to materials having reactive components that are polymerizable by exposure to at least one of the energy sources mentioned earlier. As used herein, the term “radiation curable composition” refers to a composition that comprises a radiation curable material. As used herein, the term “substantially free” means that the material is present in the composition, if at all, as an incidental impurity. In other words, the material does not effect the properties of the composition. As used herein, the term “completely free” means that the, material is not present in the composition at all.

Examples of radiation curable materials are materials susceptible to radiation cure by cationic and/or free radical cure mechanisms. As those skilled in the art will appreciate, in a cationic cure mechanism, the reactive functionality of the resin reacts by means of positively charged chemical species, while, in a free-radical cure mechanism, the, reactive functionality of the resin reacts by means of free radical (uncharged) intermediate species.

Examples of materials that are susceptible to cationic cure are epoxides, such as cycloaliphatic epoxides, vinyl ethers, oxetanes oxolanes, cyclic acetals, cyclic lactones, thiiranes, and/or thiotanes. Examples of materials that are susceptible to free radical cure include, for example, materials that have, on average, at least two ethylenically unsaturated groups per molecule bound, for example, to an aliphatic, aromatic, cycloaliphatic, araliphatic, or heterocyclic structure; or to an oligomer or polymer such as, for example, a polyether, polyolefin, polyester, polycarbonate, (meth)acrylic, or polyurethane. Specific non-limiting examples of such materials include unsaturated polyesters, (meth)acrylate-functional resins, vinyl ethers, vinyl esters, allyl ethers and/or allyl esters. As is apparent, vinyl ethers having at least two vinyl ether groups may polymerize by a cationic and/or free radical mechanism. As used herein, the term (meth)acrylate, and similar terms, is meant to encompass both acrylates and methacrylates.

In certain embodiments, the treatment layer is deposited from a composition that is substantially free or, in some cases, completely free of any film-forming resin. As used herein, the term “film-forming resin” refers to resins that can form a self-supporting continuous film on at least a horizontal surface of a substrate upon removal of any diluents or carriers present in the composition or curing.

The treatment layer can be applied to any of a variety of substrates. In certain embodiments of the present invention, however, the treatment layer is applied to a porous substrate, such as any of the exemplary porous substrates listed earlier.

The treatment layer can be applied to the substrate by any means known in the art. For example, it can be applied by brushing, dipping flow coating, conventional and electrostatic spraying. In certain embodiments, the treatment layer, once applied, is allowed to soak into the porous substrate and allowed to dry for a predetermined amount of time, such as about 1 minute.

As previously indicated, the, substrates of the present invention are at least partially cdated with a multi-layer composite coating system that also comprises a colorant layer deposited from a composition comprising a film-forming resin, a colorant, and a diluent. In certain embodiments, the coating system comprises two colorant layers, a toner layer and a stain layer. As used herein, the term “stain” refers to a translucent composition that colors a porous substrate, such as wood, while allowing some of the substrate's natural color and grain to show through. As used herein, the term “toner” refers to a composition that performs a function similar to a stain in that it colors a porous substrate, however, a “toner” is typically a low solids composition (no more than 5 weight percent solids and at least 95 weight percent solvent) and is typically applied to a-substrate at a low film thickness before a stain is applied.

In the present invention, the colorant layer is deposited from a coating composition that comprises a film-forming resin. Suitable film-forming resins include any film-forming resin typically used in the art, such as, for example, polyurethanes, acrylics, vinyls, melamines, polyvinylchlorides polyolefins, polyureas, polycarbonates, polyethers, epoxies, silicones, polyamides, and the like. In certain embodiments, such as certain cases wherein the colorant layer comprises a stain, the film-forming resin comprises an alkyd resin. As used herein, the term “alkyd resin” denotes a synthetic resin that is the reaction product of a polybasic acid or anhydride a polyhydric alcohol, and an oil fatty acid. Such resins are often prepared by polycondensation of various polybasic acids, polyhydric alcohols and fatty acids. As used herein, the term “oil fatty acid” includes, for example, drying oils, semi-drying oils, and non-drying oils, including mixtures thereof. As will be appreciated by those skilled in the art, when one or more drying oils, one or more semi-drying oils or mixtures of drying and semi-drying oils are used the coating compositions of the present invention will be capable of undergoing oxidative cure. Similarly, if a mixture of at least one of the drying oils or the semi drying oils with a non-drying oil is used, with the mixture being predominantly drying and/or semi-drying, the compositions will also undergo oxidative cure. “Predominantly drying” and/or “semi-drying” means that at least about 45 percent of the oils used are drying and/or semi-drying. Both drying and semi-drying oils contain carbon-carbon double bonds that are capable of undergoing oxidative crosslinking, whereas nondrying oils either don't contain such bonds or don't contain a sufficient number of such bonds to effect cure.

Examples of suitable drying and semi-drying oils include castor oil, dehydrated castor oil, cottonseed oil, fish oil, linseed oil, menhaden oil, oiticica oil, palm kernel oil, perilla oil, safflower oil, sardine oil, soybean oil, sunflower oil, tall oil, tung oil, and walnut oil. Examples of suitable non-drying oils include valeric acid, heptanoic acid, 2-ethyl hexanoic acid, pelargonic acid, isononanoic acid, lauric acid, coconut oil fatty acid, stearic acid and branched fatty acids containing 18 carbon atoms. Predominantly drying/semi-drying oils are often more appropriate for use in the present stains.

Suitable pdlyhydric alcohols that can be used in forming such alkyd resins include glycerol, neopentyl glycol, cyclohexanedimethanol, ethylene glycol, propylene glycol, pentaerythritol, neononyl glycol, diethylene glycol, dipropylene glycol, trimethylene glycol, trimethylolpropane, dipentaerythritol, tripentaerytyritol, and the like.

Suitable polybasic acids/anhydrides that can be used in forming such alkyd resins include polycarboxylic acids and anhydrides thereof. Examples of suitable polycarboxylic acids include phthalic acid, isophthalic acid, terephthalic acid, tetrahydrophthalic acid, hexahydrophthalic acid, adipic acid, azelaic acid, glutaric acid, 3,3-diethylglutaric acid, malonic acid, pimelic acid, sebacic acid, suberic acid, succinic acid, 2,2-dimethylsuccinic acid, 2-methylsuccinic acid, dodecenylsuccinic acid, itaconic acid, fumaric acid, maleic acid, citraconic acid, diethyl maleic acid, and trimellitic acid; the anhydrides of those polybasic acids are also suitable. Polybasic acids having greater than three acid moieties or the higher polyfunctional alcohols should not be utilized in amounts that will cause the alkyd resin to gel during preparation.

In certain embodiments, for example in certain instances where the composition comprises a toner composition, the film-forming resin comprises a cellulosic resin. As used herein, the term “cellulosic resin” refers to the generally known thermoplastic polymers which are derivatives of cellulose, examples of which include: nitrocellulose; organic esters and mixed esters of cellulose such as cellulose acetate, cellulose propionate, cellulose butyrate, and cellulose acetate butyrate; and organic ethers of cellulose such as ethyl cellulose.

In certain embodiments, such as where the coating composition from which the colorant layer is deposited comprises a stain, the composition comprises 0.25 up to 15 percent by weight of film-forming resin or, in some embodiments, 9 up to 15 percent by weight, or, in yet other embodinients, 10 up to 12 percent by weight of film-forming resin based on the total weight of the composition. In certain embodiments, such as where the coating composition from which the colorant layer is deposited comprises a toner, the composition comprises 0.25 up to 5 percent by weight of film-forming resin or, in some embodiments, 0.5 up to 2 percent by weight, or, in yet other embodiments, 0.5 up to 1.5 percent by weight of film-forming resin based on the total weight of the composition.

In certain embodiments, the composition from which the one or more colorant layers is deposited is substantially free or, in some cases, completely free, of radiation curable material. In other embodiments, however, such materials may be included in such compositions. For example, in certain embodiments, the colorant layer is deposited from a composition that comprises a polymer comprising an alkyd portion and a free radical curable portion. Such compositions are disclosed in United States Patent Application Publication No. 2004-0013895 A1 at [0005] to [0022], which is incorporated herein by reference.

As previously indicated, the compositions from which the colorant layer is deposited also comprise a colorant. The colorant may comprise one or more pigments, dyes, and/or tints. In certain embodiments, any combination of pigments, dyes and/or tints suitable for use in a wood toner and/or wood stain is used. Such products are widely commercially available such as from Dupont, BASF, and Elementis Specialties, among others. In certain embodiments, such compositions comprise 0.1 up to 30 percent by weight of the colorant or, in some embodiments, 1 up to 6 percent by weight of the colorant, based on the total weight of the composition.

In addition, the compositions from which the colorant layer is deposited also comprise a diluent. Suitable diluents include those identified earlier with respect to the treatment layer. In certain embodiments, the diluent is present in such compositions of the present invention in an amount ranging from 5 to 80 weight percent based on total weight of the composition, such as 30 to 50 percent.

In certain embodiments, even those embodiments wherein the colorant layer is deposited from a composition that is substantially free of radiation curable materials, such compositions also comprise a radiation cure initiator, such as any of those identified earlier with respect to the treatment layer. In certain embodiments, such compositions comprise 0.01 up to 15 percent by weight of radiation cure initiator or, in some embodiments, 0.01 up to 10 percent by weight, or, in yet other embodiments, 0.01 up to 5 percent by weight of radiation cure initiator, based on the total weight of the composition.

In certain embodiments, the comprositions from which the colorant layer is deposited comprise an additive comprising an organo-silicon or organo-fluorine containing molecule or polymer, such as any of those materials that were identified earlier with respect to the treatment layer, such as the amino silanes and/or epoxy silanes that were previously identified. In certain embodiments, the coating compositions of the present invention comprise up to 2 percent by weight of organosilane or, in some embodiments, 0.1 up to 2 percent by weight of organosilane, based on the total weight of the composition.

In addition, the compositions from which the colorant layer is deposited can contain other optional ingredients including ultraviolet absorbers, pigments, and inhibitors known in the art. In addition, various fillers, plasticizers, flow control agents, surfactants and other known formulating additives may be used. Also useful are aluminum or titanium chelating crosslinkers, such as ALUSEC 510 ethyl acetoacetato-di-2-ethoxy aluminum manufactured by Manchem Ltd. or TYZOR TPT tetraisopropyl titanate manufactured by DuPont. An antiskin agent, such as methyl ethyl ketoxime may be added to, for example, improve package stability. Fillers and flatting agents, such as clay, talc, silica, and the like can be added. Suitable silicas are commercially available from W.R. Grace and Company as SYLOID 169 and from DeGussa Corporation as AEROSIL 9723. Sag resistance additives, such as cellulose acetate, butyrate 551-0.2 from Eastman Chemicals can also be included, as can other additives that enhance properties. Various additives, when used, typically comprise no more than 30 weight percent, such as no more than 10 weight percent, of the coating composition.

The coating compositions from which the colorant layer is deposited can be applied to the substrate by any means known in the art. For example, they can be applied by brushing, dipping, roll coating, flow coating, conventional and electrostatic spraying. Once applied, the colorant layer coating composition may be allowed to soak into the porous substrate for a predetermined amount of time, and the excess wiped off. Multiple layers can be applied. The colorant layer may then be cured. For example, when the compositions from which such layer are deposited contain free radical curable materials, such as those mentioned earlier that include a polymer comprise an alkyd portion and a free radical curable portion, such compositions can then be cured by initiating free radical cure. This can be done, for example, by exposing the coated substrate to UV radiation.

In certain embodiments, the coating composition from which the colorant layer is deposited may be cured by oxidative cure accomplished by allowing the coated substrate to be exposed to ambient or elevated temperature conditions. For example, the ambient or elevated temperature conditions can be those generally considered to be “air dry” or “force dry” conditions. This occurs at temperatures ranging from about 13° C. to 250° C. such as 20° C. to 150° C., or 50° C. to 90° C. Oxidative cure in the absence of accelerating conditions can take place over the course of several days to several weeks. As will be appreciated, oxidative cure will occur after free radical and/or cationic cure in those embodiments wherein the coating compositions from which the colorant layer is deposited comprises materials susceptible to free radical and/or cationic cure.

The multi-layer coating systems of the present invention also comprise at least one of a sealer and topcoat deposited from a radiation curable composition, applied over at least a portion of the colorant layer. As used herein, the term “sealer” refers to a coating applied directly to a colorant layer, such as a toner and/or stain, while a “topcoat” refers to a coating applied directly to the sealer. In the coating systems of the present invention, the sealer and/or topcoat are deposited from radiation curable compositions, such as compositions comprising a radiation curable material susceptible to cationic and/or free radical cure. For example, in certain embodiments the sealer and/or the topcoat are deposited from a composition comprising a polymer comprising an alkyd portion and a free radical curable portion, such as is described in U.S. patent application Publication No. 2004-0013895 A1, which is incorporated by reference herein. In certain embodiments, the radiation, curable composition from which at least one of the sealer and topcoat is deposited comprises a 100% solids or a waterborne composition.

In certain embodiments, the sealer and/or topcoat are deposited from a radiation curable composition that comprises a radiation curable material susceptible to cationic cure. In such cases, it is often desirable to include a cationic photoinitiator in the coating composition from which the colorant layer and/or the treatment layer is deposited. In other embodiments of the present invention, the sealer and/or topcoat are deposited from a radiation curable composition that comprises a radiation curable material susceptible to free radical cure. In such cases, it is often desirable to include a free radical photoinitiator in the coating composition from which the colorant layer and/or the treatment layer is deposited.

In certain embodiments, the treatment layer is first applied to the substrate, followed by the colorant layer and at least one of a sealer and a topcoat. In other embodiments of the present invention, however, a toner is first applied to the substrate. In such embodiments, the toner may or may not undergo oxidative cure before application of a treatment layer, followed by application of a stain, which is applied to the substrate after the treatment layer is allowed to dry. The stain may or may not undergo oxidative cure before application of the sealer and/or topcoat (application of the sealer and/or topcoat to the uncured stain and/or toner will be understood by one skilled in the art as a “wet on wet” application). After the sealer and/or topcoat is applied, these layers are at least partially cured. While not being bound by any theory, it is believed that some radiation curable monomers present in the sealer and/or topcoat radiation curable compositions may migrate into the stain layer, the toner layer, the treatment layer and/or the porous substrate during application and prior to cure. The presence of radiation curable initiators in the stain layer, the toner layer, the treatment layer and/or the porous substrate may allow the radiation curable monomers that have migrated therein to be cured during cure of the sealer and/or topcoat. As a result, interlayer bonding may occur, and interlayer adhesion as well as adhesion to the substrate improved. As indicated, however, the present invention is not limited to this mechanism. As a result, the multi-layer composite coatings of the present invention may offer desirable levels of adhesion, toughness, appearance, feel and/or stain/solvent resistance, among other properties. As used herein, the term “partial cure” refers to any stage of curing between complete cure and no cure.

In certain embodiments, the substrates of the present invention are coated with a multi-layer composite coating exhibiting a tape adhesion of at least 50%, with tape adhesion testing being performed according to ASTM D-359. In certain embodiments, such coatings exhibit a tape adhesion of at least 85% or, in some cases, 100%.

In certain embodiments, the substrates of the present invention are coated with a multi-layer composite coating exhibiting nickel scrape resistance of at least 8. Nickel scrape resistance is a quantitative evaluation of a coating system's resistance to gouge. As used herein, nickel scrape resistance is tested using five replicates on a single sample and with results reported in comparison to a control coating system. The test may be conducted using a United States Government 5 cent coin without obviously worn surfaces. The nickel is grasped between the thumb and forefinger and, using medium to firm pressure, the nickel edge is scraped over the coated surface. The pressure # required to gouge the coated surface is assigned a whole number from 1 to 10 with 1 being minimal effort and 10 being maximum effort.

As will be appreciated by the skilled artisan, the present invention is further directed'to methods for improving the adhesion of a multi-layer composite coating system to a porous substrate, which can be measured by the tape adhesion test described earlier. The multi-layer composite coating system comprises at least one colorant layer deposited onto the substrate from at least one composition comprising a film-forming resin, a colorant, and a diluent, and at least one of a sealer and topcoat deposited from a radiation curable composition, wherein the sealer and/or topcoat is applied over at least a portion of the at least one colorant layer. These methods comprise the step of depositing a treatment layer from a composition comprising a radiation cure initiator to the substrate prior to depositing the at least one colorant layer onto the substrate. As used herein, the term “prior to” encompasses anytime “prior to,” including, but not limited to, “immediately prior to.”

The present invention also provides methods for at least partially coating a porous substrate with a multi-layer composite coating composition. These methods comprise: (a) applying a treatment layer to at least a portion of the substrate, wherein the treatment layer is deposited from a composition comprising a radiation cure initiator; (b) applying a colorant layer to the porous substrate; and (c) applying at least one of sealer and topcoat; deposited from a radiation curable composition, over at least a portion of the colorant layer. In these methods of the present invention, the colorant layer is deposited from a composition comprising a film-forming resin, a colorant and a diluent. The colorant layer, the sealer and/or topcoat coating compositions can then be cured. Thus, for example, the sealer and/or topcoat compositions may be cured by irradiation with ultraviolet rays as is known to those skilled in the art. In certain embodiments, curing can be completed in less than one minute.

In certain embodiments, an ultraviolet light source having a wavelength range of 180 to 4000 nanometers may be used to cure the sealer and/or topcoat compositions. For example, sunlight, mercury lamps, arc lamps, xenon lamps, gallium lamps, and the like may be used. In one example, the sealer and/or topcoat compositions may be cured by a medium pressure mercury lamp having an intensity of 48 to 360 W/cm, for a total exposure of 100 to 2000 mJ/cm², such as 500 to 1000 mJ/cm² as measured by a POWERMAP UV Radiometer commercially available from EIT Inc., Sterling, Va.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1A

A wood treatment composition was prepared using the ingredients listed in Table 1. The ingredients were added to a paint can with agitation from a Cowles blade. After mixing of all ingredients, mixing was continued from approximately 5 to 10 minutes to ensure homogenecity.

TABLE 1

| Ingredient | Parts By Weight (grams) |
|---|---|
| Ethanol | 25 |
| Acetone | 25 |
| Z-6020¹ | 1 |
| Irgacure 819² | 1 |

¹N-(b-aminoethyl)-g-aminopropyltrimethoxysilane available from Dow Corning Corp.
²A bis acyl phosphine oxide photoinitiator available from Ciba Specialty Chemicals Corp.

### Example 1B

A wood treatment composition was prepared using the ingredients listed in Table 2. The composition was prepared in the same manner as described for Example 1A.

TABLE 2

| Ingredient | Parts By Weight (grams) |
|---|---|
| Ethanol | 25 |
| Acetone | 25 |
| Z-6040¹ | 1 |
| Irgacure 819² | 1 |

¹glycidoxypropyltrimethoxysilane available from Dow Corning Corp.
²A bis acyl phosphine oxide photoinitiator available from Ciba Specialty Chemicals Corp.

### Example 1C

A wood treatment composition was prepared using the ingredients listed in Table 3. The composition was prepared in the same manner as described for Example 1A.

TABLE 3

| Ingredient | Parts By Weight (grams) |
|---|---|
| Ethanol | 25 |
| Acetone | 25 |
| Silquest A-1100¹ | 1 |
| Irgacure 819² | 1 |

¹gamma-aminopropyltriethoxysilane available from OSI Specialties Inc.
²A bis acyl phosphine oxide photoinitiator available from Ciba Specialty Chemicals Corp.

### Example 1D

A wood treatment composition was prepared using the ingredients listed in Table 4. The composition was prepared in the same manner as described for Example 1A.

TABLE 4

| Ingredient | Parts By Weight (grams) |
|---|---|
| Ethanol | 25 |
| Acetone | 25 |
| Silquest A-174¹ | 1 |
| Irgacure 819² | 1 |

¹gamma-methacryloxypropyltrimethoxysilane available from OSI Specialties Inc.
²A bis acyl phosphine oxide photoinitiator available from Ciba Specialty Chemicals Corp.

### Example 1 E

A wood treatment composition was prepared using the ingredients listed in Table 5. The composition was prepared in the same manner as described for Example 1A.

TABLE 5

| Ingredient | Parts By Weight (grams) |
|---|---|
| Ethanol | 25 |
| Acetone | 25 |
| Silquest A-186¹ | 1 |
| Irgacure 819² | 1 |

¹A beta-(3,4-epoxycyclo hexyl)ethyltrimethoxy silane available from OSI Specialties Inc.
²A bis acyl phosphine oxide photoinitiator available from Ciba Specialty Chemicals Corp.

### Example 1F

A wood treatment composition was prepared using the ingredients listed in Table 6. The composition was prepared in the same manner as described for Example 1A.

TABLE 6

| Ingredient | Parts By Weight (grams) |
|---|---|
| Ethanol | 25 |
| Acetone | 25 |

### Examples 2A to 2F

Maple veneers were sanded with 220 grit sandpaper. The wood treatment compositions were spray applied onto the veneers using a single pass of a Binks Model 2001 hand-held spray gun using 30 to 40 psi air pressure to achieve a uniform layer. A rouge toner (C1442A33 from PPG Industries, Inc.) was then applied using a single pass of a Binks Model 2001 hand-held spray gun using 30 to 40 psi air pressure to achieve a uniform layer. The coated veneers were given a one-minute ambient temperature flash and then a rouge wiping stain (C1453A31 from PPG Industries, Inc.) was then applied using a single pass of a Binks Model 2001 hand-held spray gun using 30 to 40 psi air pressure to achieve a uniform layer, and then the excess was rag wiped. After a fifteen-minute flash at ambient-temperature, the veneers were baked for four minutes at 180° F. A sealer composition (R1659Z49 from PPG Industries, Inc.) was heated to about 140° F. then applied at a dry film thickness of about 0.4 mils using a Devilbiss HVLP hand-held spray gun using 60 psi air pressure with the veneer at a surface temperature of about 110° F. The coated veneers were given 700 mj/cm² of UV-A exposure, and then allowed to cool at ambient temperature for an additional five minutes. The cured veneer was then sanded with 280 grit sandpaper. A topcoat was then applied using a UV curable topcoat composition (R1594Z83 from PPG Industries, Inc.) heated to about 140° F. applied at a dry film thickness of about 0.6 mils using a Devilbiss JGHV-530 hand-held spray gun using 60 psi air pressure with the veneer at a surface temperature of about 110° F. The coated veneers were given 1050 mj/cm² of UV-A exposure.

After application and curing of the topcoat, the veneers were allowed to rest at room temperature overnight. All of the veneers were then tested as described in Table 7.

TABLE 7

| Example | Tape Adhesion¹ | Nickel Scrape² |
|---|---|---|
| 2A | 5B | 5 |
| 2B | 3B | 3 |
| 2C | 3B | 3 |
| 2D | 3B | 3 |
| 2E | 3B | 3 |
| 2F | 0B | 0 |
| ¹Performed using 3M Scotch Masking Tape 250 3005, with performance rated on the following scale: 5B = 100% adhesion; 4B = 99%-95% adhesion; 3B = 85%-94% adhesion; 2B = 65%-84% adhesion; 1B = 35%-64% adhesion; 0B = 0%-34% adhesion. | | |
| ²Nickel scrape adhesion is a quantitative evaluation of a coating system's resistance to gouge. Nickel scrape was tested using five replicates on a single sample and with results reported in comparison to a control coating system. The test was conducted using a U.S. Government 5 cent coin without obviously worn surfaces. The nickel was grasped between the thumb and forefinger and, using medium to firm pressure, the nickel edge was scraped over the coated surface. The pressure | | |
| # # required to gouge the coated surface was assigned a whole number from 0 to 5 with 0 being minimal effort and 5 being maximum effort. | | |

### Example 3A

A wood treatment composition was prepared using the ingredients listed in Table 8. The ingredients were added to a paint can with agitation from a Cowles blade. After mixing of all ingredients, mixing was continued from approximately 5 to 10 minutes to ensure homogenecity.

TABLE 8

| Ingredient | Parts By Weight (grams) |
|---|---|
| Isopropanol | 60 |
| Diacetone alcohol | 5 |
| Butyl acetate | 10 |
| Acetone | 25 |
| Z-6030¹ | 2 |
| Irgacure 819² | 2 |

¹A gamma-methacryloxypropyltrimethoxysilanes available from Dow Corning Corp.
²A bis acyl phosphine oxide photoinitiator available from Ciba Specialty Chemicals Corp.

### Example 3B

A wood treatment composition was prepared using the ingredients listed in Table 9. The composition was prepared in the same manner as described for Example 1A.

TABLE 9

| Ingredient | Parts By Weight (grams) |
|---|---|
| Isopropanol | 60 |
| Diacetone alcohol | 5 |
| Butyl acetate | 10 |
| Acetone | 23 |
| Irgacure 819¹ | 2 |

¹A bis acyl phosphine oxide photoinitiator available from Ciba Specialty Chemicals Corp.

### Example 3C

A wood treatment composition was prepared using the ingredients listed in Table 10. The composition was prepared in the same manner as described for Example 1A.

TABLE 10

| Ingredient | Parts By Weight (grams) |
|---|---|
| Isopropanol | 60 |
| Diacetone alcohol | 5 |
| Butyl acetate | 10 |
| Acetone | 25 |
| Z-6020¹ | 2 |
| Irgacure 819² | 2 |

¹N-(b-aminoethyl)-g-aminopropyltrimethoxysilane available from Dow Corning Corp.
²A bis acyl phosphine oxide photoinitiator available from Ciba Specialty Chemicals Corp.

### Examples 4A to 4C

In these Examples, maple veneers were sanded with 220 grit sandpaper. Each of the wood treatment compositions 3A to 3C were spray applied onto the veneers using a single pass of a Binks Model 2001 hand-held spray gun using 30 to 40 psi air pressure to achieve a uniform layer. After about a one-minute room temperature flash, a rouge toner (C1442A33 from PPG Industries, Inc.) was then applied using a single pass of a Binks Model 2001 hand-held spray gun using 30 to 40 psi air pressure to achieve a uniform layer. The coated veneers were given a one-minute ambient temperature flash and then a rouge wiping stain (C1453A31 from PPG Industries, Inc.) was then applied using a single pass of a Binks Model 2001 hand-held spray gun using 30 to 40 psi air pressure to achieve a uniform layer, and then the excess was rag wiped. After a fifteen-minute flash at ambient temperature, and a four minute bake at 180° F., a sealer composition (R1659Z49 from PPG Industries, Inc.) was heated to about 140° F. then applied at a dry film thickness of about 0.4 mils using a Devilbiss HVLP hand-held spray gun using 60 psi air pressure with the veneer at a surface temperature of about 110° F. The coated veneers were given 700 mj/cm² of UV-A exposure, and then allowed to cool at ambient temperature for an additional five minutes. The cured veneer was then sanded with 280 grit sandpaper. A topcoat was then applied using a UV curable topcoat composition (R1594Z83 from PPG Industries, Inc.) heated to about 140° F. applied at a dry film thickness of about 0.6 mils using a Devilbiss JGHV-530 hand-held spray gun using 60 psi air pressure with the veneer at a surface temperature of about 110° F. The coated veneers were given 1050 mj/cm² of UV-A exposure.

After application and curing of the topcoat, the veneers were allowed to rest at room temperature overnight. All of the veneers were then tested as described in Table 11.

TABLE 11

| Example | Tape Adhesion¹ | Nickel Scrape² |
|---|---|---|
| 4A | 3B | Good |
| 4B | 4B | Fair |
| 4C | 5B | Best |
| ¹Performed using 3M Scotch Masking Tape 250 3005, with performance rated on the following scale: 5B = 100% adhesion; 4B = 99%-95% adhesion; 3B = 85%-94% adhesion; 2B = 65%-84% adhesion; 1B = 35%-64% adhesion; 0B = 0%-34% adhesion. | | |
| ²Nickel scrape adhesion is a quantitative evaluation of a coating system's resistance to gouge. Nickel scrape was tested using five replicates on a single sample and with results reported in comparison to a control coating system. The test was conducted using a U.S. Government 5 cent coin without obviously worn surfaces. The nickel was grasped between the thumb and forefinger and, using medium to firm pressure, the nickel edge was scraped over the coated surface. The | | |
| # pressure # required to gouge the coated surface was judged on a poor, fair, good, and best criteria. | | |

### Examples 5A to 5C

In these Examples, maple veneers were sanded with 220 grit sandpaper. A rouge toner (C1422A33 from PPG Industries, Inc.) was then applied using a single pass of a Binks Model 2001 hand-held spray gun using 30 to 40 psi air pressure to achieve a uniform layer. The coated veneers were given a one-minute ambient temperature flash and then each of the wood treatment compositions 3A to 3C were spray applied onto the veneers using a single pass of a Binks Model 2001 hand-held spray gun using 30 to 40 psi air pressure to achieve a uniform layer. After about a one-minute room temperature flash, a rouge wiping stain (C1453A31 from PPG Industries, Inc.) was then applied using a single pass of a Binks Model 2001 hand-held spray gun using 30 to 40 psi air pressure to achieve a uniform layer, and then the excess was rag wiped. After a fifteen-minute flash at ambient temperature, and a four minute bake at 180° F., a sealer composition (R1659Z49 from PPG Industries, Inc.) was heated to about 140° F. then applied at a dry film thickness of about 0.4 mils using a Devilbiss HVLP hand-held spray gun using 60 psi air pressure with the veneer at a surface temperature of about 110° F. The coated veneers were given 700 mj/cm² of UV-A exposure, and then allowed to cool at ambient temperature for an additional five minutes. The cured veneer was then sanded with 280 grit sandpaper. A topcoat was then applied using a UV curable topcoat composition (R1594Z83 from PPG Industries, Inc.) heated to about 140° F. applied at a dry film thickness of about 0.6 mils using a Devilbiss JGHV-530 hand-held spray gun using 60 psi air pressure with the veneer at a surface temperature of about 110° F. The coated veneers were given 1050 mj/cm² of UV-A exposure.

After application and curing of the topcoat, the veneers were allowed to rest at room temperature overnight. All of the veneers were then tested as described in Table 12.

TABLE 12

| Example | Tape Adhesion¹ | Nickel Scrape² |
|---|---|---|
| 5A | 5B | Good |
| 5B | 5B | Fair |
| 5C | 5B | Best |
| ¹Performed using 3M Scotch Masking Tape 250 3005, with performance rated on the following scale: 5B = 100% adhesion; 4B = 99%-95% adhesion; 3B = 85%-94% adhesion; 2B = 65%-84% adhesion; 1B = 35%-64% adhesion; 0B = 0%-34% adhesion. | | |
| ²Nickel scrape adhesion is a quantitative evaluation of a coating system's resistance to gouge. Nickel scrape was tested using five replicates on a single sample and with results reported in comparison to a control coating system. The test was conducted using a U.S. Government 5 cent coin without obviously worn surfaces. The nickel was grasped between the thumb and forefinger and, using medium to firm pressure, the nickel edge was scraped over the coated surface. The | | |
| # pressure # required to gouge the coated surface was judged on a poor, fair, good, and best criteria. | | |

### Examples 6A to 6C

In these Examples, maple veneers were sanded with 220 grit sandpaper. A rouge toner (C1442A33 from PPG Industries, Inc.) was then applied using a single pass of a Binks Model 2001 hand-held spray gun using 30 to 40 psi air pressure to achieve a uniform layer. After about a one-minute room temperature flash, a rouge wiping stain (C1453A31 from PPG Industries, Inc.) was then applied using a single pass of a Binks Model 2001 hand-held spray gun using 30 to 40 psi air pressure to achieve a uniform layer, and then the excess was rag wiped. The coated veneers were given a one-minute ambient temperature flash and then each of the wood treatment compositions 3A to 3C were spray applied onto the veneers using a single pass of a Binks Model 2001 hand-held spray gun using 30 to 40 psi air pressure to achieve a uniform layer. After a fifteen-minute flash at ambient temperature, and a four minute bake at 180° F., a sealer composition (R1659Z49 from PPG Industries, Inc.) was heated to about 140° F. then applied at a dry film thickness of about 0.4 mils using a Devilbiss HVLP hand-held spray gun using 60 psi air pressure with the veneer at a surface temperature of about 110° F. The coated veneers were given 700 mj/cm² of UV-A exposure, and then allowed to cool at ambient temperature for an additional five minutes. The cured veneer was then sanded with 280 grit sandpaper. A topcoat was then applied using a UV curable topcoat composition (R1594Z83 from PPG Industries, Inc.) heated to about 140° F. applied at a dry film thickness of about 0.6 mils using a Devilbiss JGHV-5306 hand-held spray gun using 60 psi air pressure with the veneer at a surface temperature of about 110° F. The coated veneers were given 1050 mj/cm² of UV-A exposure.

After application and curing of the topcoat, the veneers were allowed to rest at room temperature overnight. All of the veneers were then tested as described in Table 13.

TABLE 13

| Example | Tape Adhesion¹ | Nickel Scrape² |
|---|---|---|
| 6A | 4B | Good |
| 6B | 4B | Fair |
| 6C | 5B | Best |
| ¹Performed using 3M Scotch Masking Tape 250 3005, with performance rated on the following scale: 5B = 100% adhesion; 4B = 99%-95% adhesion; 3B = 85%-94% adhesion; 2B = 65%-84% adhesion; 1B = 35%-64% adhesion; 0B = 0%-34% adhesion. | | |
| ²Nickel scrape adhesion is a quantitative evaluation of a coating system's resistance to gouge. Nickel scrape was tested using five replicates on a single sample and with results reported in comparison to a control coating system. The test was conducted using a U.S. Government 5 cent coin without obviously worn surfaces. The nickel was grasped between the thumb and forefinger and, using medium to firm pressure, the nickel edge was scraped over the coated surface. The | | |
| # pressure # required to gouge the coated surface was judged on a poor, fair, good, and best criteria. | | |

Whereas particular embodiments of this invention have been described above for purposes of illustration, it will be evident to those skilled in the art that numerous variations of the details of the present invention may be made without departing from the invention as defined in the appended claims.

We claim:

1. A substrate at least partially coated with a multi-layer composite coating system comprising:
(a) a treatment layer deposited from a composition comprising a radiation cure initiator and a diluent, wherein the composition is substantially free of radiation curable material,
(b) a colorant layer deposited from a composition comprising a film-forming resin, a colorant, and a diluent, and
(c) at least one of a sealer and topcoat deposited from a radiation curable composition, wherein the sealer and/or topcoat is applied over at least a portion of the colorant layer and the treatment layer.

2. The substrate of claim 1, wherein the substrate comprises a porous substrate.

3. The substrate of claim 2, wherein the substrate comprises wood.

4. The substrate of claim 1, wherein the treatment layer is deposited from a composition comprising a radiation cure initiator comprising a photoinitiator selected from a cationic photoinitiator and/or a free radical photoinitiator.

5. The substrate of claim 4, wherein the photoinitiator comprises 2,4,6-trimethylbenzoyldiphenylphosphine oxide.

6. The substrate of claim 1, wherein the treatment layer is deposited from a composition further comprising an organo-silicon or organo-fluorine material.

7. The substrate of claim 6, wherein the organo-silicon material comprises an organo silane.

8. The substrate of claim 7, wherein the organo silane comprises an amino silane, an epoxy silane, or a mixture thereof.

9. The substrate of claim 1, wherein the treatment layer is deposited from a composition that is substantially free of any film-forming resin.

10. The substrate of claim 1, wherein the multi-layer composite coating system comprises two colorant layers comprising a toner layer and a stain layer.

11. The substrate of claim 10, wherein the stain layer is deposited from a composition comprising an alkyd resin.

12. The substrate of claim 10, wherein the toner layer is deposited from a composition comprising a cellulosic resin.

13. The substrate of claim 1, wherein the composition from which the colorant layer is deposited is substantially free of radiation curable material.

14. The substrate of claim 1, wherein the composition from which the colorant layer is deposited comprises a polymer comprising an alkyd portion and a free radical curable portion.

15. The substrate of claim 1, wherein either:
(i) the composition from which the treatment layer is deposited comprises a cationic photoinitiator when the at least one of a sealer and topcoat are deposited from a radiation curable composition comprising a radiation curable material susceptible to cationic cure, or
(ii) the composition from which the treatment layer is deposited comprises a free radical photoinitiator when the at least one of a sealer and topcoat are deposited from a radiation curable composition comprising a radiation curable material susceptible to free radical cure.

16. A method for at least partially coating the substrate of claim 1, comprising:
(a) applying the colorant layer to at least a portion of the substrate,
(b) applying the treatment layer to at least a portion of the substrate;
(c) applying the at least one of a sealer and topcoat, over at least a portion of the colorant layer and/or the treatment layer, and
(d) curing the sealer and/or topcoat.

17. The method of claim 16, wherein the sealer and/or topcoat is cured by irradiation with ultraviolet rays.

18. A method for improving the adhesion of a multi-layer composite coating system to a porous substrate, wherein the coating system comprises (i) a colorant layer deposited onto the substrate from a composition comprising a film-forming resin, a colorant, and a diluent, and (ii); at least one of a sealer and topcoat deposited from a radiation curable composition, wherein the sealer and/or topcoat is applied over at least a portion of the colorant layer, the method comprising:
depositing a treatment layer from a composition comprising a radiation cure initiator to the substrate prior to depositing the sealer and/or topcoat onto the substrate, wherein the composition from which the treatment layer is deposited is substantially free of radiation curable material.

19. The method of claim 18, wherein:
(i) the composition from which the treatment layer is deposited comprises a cationic photoinitiator when the at least one of a sealer and topcoat is deposited from a radiation curable composition comprising a radiation curable material susceptible to cationic cure, and
(ii) the composition from which the treatment layer is deposited comprises a free radical photoinitiator when the at least one of a sealer and topcoat is deposited from a radiation curable composition comprising a radiation curable material susceptible to free radical cure.

20. The method of claim 18, wherein the composition from which the treatment layer is deposited is substantially free of any film-forming resin.
